(19) United States
(12) Patent Application Publication
(10) Pub. No.: US 2002/0133825 A1
(43) Pub. Date: Sep. 19, 2002

(54) System and method for transmitting information including video images to carriages of trains

(75) Inventors: Jaime Foster Rufilanchas, Madrid (ES); Fernando Trapero Gimenez, Madrid (ES)

Correspondence Address: OSTROLENK FABER GERB & SOFFEN, 1180 AVENUE OF THE AMERICAS, NEW YORK, NY, 100368403

(73) Assignee: MEDIA TRANS Tech Solutions, S.L.

(21) Appl. No.: 09/870,543

(22) Filed: May 30, 2001

(30) Foreign Application Priority Data
Mar. 15, 2001 (ES) P200100608

(51) Int. Cl. H04N 7/18

(52) U.S. Cl. 725/75

(57) ABSTRACT

A system and a method for transmitting information including video images to carriages of trains and visually displaying the video images in the carriages. The system includes:

at least one screen (1) situated in at least one carriage (2) of a train;

at least one DBV-T transmitter (2) equipped with means for transmitting a signal with C-OFDM modulation;

at least two antennae (5, 6) situated on the train;

at least one DBV-T receiver (7) situated on board the train and equipped with means for receiving the signal with C-OFDM modulation via said at least two antennae (5, 6);

means for visually displaying images corresponding to the signal received in the DBV-T receiver, on said at least one screen (1).

### FIELD OF THE INVENTION

The invention relates to a system and method for transmitting information to carriages of trains, for example trains of a suburban railway. More specifically, it deals with the transmission of information including video images, preferably audiovisual information, which is shown on screens in the carriages.

### BACKGROUND OF THE INVENTION

A present-day system for giving information to the passenger on a train is based on LED technology and has a very simple content structure, showing very basic information such as the temperature, the time of day or an indication of the next station. Communication with the outside is practically nonexistent, and the only information which passes through is that supplied by beacons (that is to say a few bytes). That being so, and with the exception of the information supplied by the above-mentioned beacons, the information displayed corresponds to information recorded on a device which is mounted on board the train, and information made available by a thermometer on the train. This system does not allow the passengers on board the train to receive visual or audiovisual information with a high information content from the outside, for example video images projected onto screens on board the train. That being so, in the present-day system, the passengers cannot receive updated information, such as audiovisual information with news, etc., during the trip.

The possibility has been envisaged of transmitting this type of image or audiovisual information to trains via a mobile telephony system, GSM in practice, but this system does not allow the transmission of information at a high enough speed to make it possible to view high-quality video images on the trains.

Another problem is that any system for transmitting information to trains has to be compatible with the local standards which govern the railway environment in each country or region, for example, as regards the matter of the risk of interference between electromagnetic signals.

Around 1994, European television companies (including producers and manufacturers) agreed on a new standard for digital broadcast of video sequences. Said standard was called Digital Video Broadcast (DVB) and was intended to replace the previous (analog) PAL and SECAM broadcast standards. The digital character of the signals provided for increased quality of the video transmission and provided a basis for services that could not be implemented under the previous analog standards. Under the DVB standard, the video sequences are coded using MPEG-2, then interleaved and error coded. The Reduced Reed Solomon could be appropriate for this error coding. The broadcast is performed using the Orthogonal Frequency Division and Multiplexing (OFDM).

A DVB consumer receiver can be constituted by a box called an Integrated Receiver Decoder (IRD). Said box can contain only a receiver and an MPEG decoder. The IRD can have conventional RF and SCART interfaces to antenna, cable and TV/VCR.

Further information regarding DVB can be found in “Digital Video Broadcasting-Technology, Standards and Regulation” (Author: Ronald D Bruin; ISBN 0890067430) and in “Digital Video Broadcasting: The international Standard for Digital TV” (Author: Ulrich Reimers; ISBN: 3540609466) which are herewith incorporated by reference.

In this application, the expression “C-OFDM” or “Coded-OFDM” is used to denote that the signal transmitted or broadcasted with OFDM modulation has been interleaved and error coded using a convolutional code, for example, the Reduced Reed Solomon code, before transmission or broadcasting with OFDM. That is, transmission or broadcasting with C-OFDM modultation means that the signal is first interleaved and error coded using a convolutional code, and then transmitted or broadcasted using OFDM.

The video transmission system using DBV-T technology (Digital Broadcasting Video-Television), or terrestrial digital television, could at first sight be a solution to the problem of the lack of information-transmission capacity. Nevertheless, said system has been assessed as being difficult to apply to the railway environment since the technical conditions which exist are enough to make it difficult to commission such a system in such an environment and, especially, in a suburban railway in which the trains pass through tunnels during the whole of their trip or during a substantial part of it.

One of the main obstacles posed to the transmission of a digital signal in an environment such as a suburban railway (such as the Madrid Metro, etc.), is that produced by the multiple reflections—multipath—of the signal in the tunnels, which cause fading effects to occur in the signal.

Fading is distortion caused by the variations in the physical characteristics of the channel which has the result of a reduction in the received power. The greatest distortions are caused by deep fading effects which are frequency-selective, affecting the various frequency components of the transmitted signal differently. In this way, some frequencies will be very much attenuated while others may have an increase in power. They are usually caused by the existence of multipath, interference being caused between the beams which reach the receiver, the resultant signal being the sum of the signals which reach it.

As an immediate consequence of the attenuation suffered by the carriers most affected by fading, it can be said that, if the noise level in the channel is sufficiently high, it will not be possible to recover the information transported by the carriers, a fact which will give rise to the appearance of an error burst on decoding as a consequence of the loss of the symbols which modulate them.

### DESCRIPTION OF THE INVENTION

The invention consists of a system for transmitting information including video images to carriages of trains and visually displaying the video images in the carriages. The system includes:

at least one screen situated in at least one carriage of a train;

at least one DBV-T transmitter (“Digital Broadcasting Video-Television”; Terrestrial Digital Television) equipped with means for transmitting a signal with C-OFDM (“Coded Orthogonal Frequency Division Multiplexing”) modulation;

at least two antennae situated on the train;

at least one DBV-T receiver situated on board the train and equipped with means for receiving the signal with C-OFDM modulation via said at least two antennae;

means for visually displaying images corresponding to the signal received in the DBV-T receiver, on said at least one screen.

The invention also refers to a method for transmitting information including video images to carriages of trains for visually displaying video images on screens in the carriages. The method comprises at least the following steps:

a video signal is transmitted from at least one DBV-T transmitter, said signal being transmitted with C-OFDM modulation;

said signal is picked up with at least two antennae situated on the train;

said signal is sent from the antennae to a DBV-T receiver situated on board the train; and

the images corresponding to the video signal are visually displayed on at least one screen.

The train may be a suburban-railway train.

The DBV-T system may feature a sufficient bandwidth (around 8 MHz) to accommodate up to five independent digital television channels with acceptable quality.

In order to solve the problems mentioned in the foregoing paragraph and which refer to the fading of the signal, use is made, for the first time in a suburban-railway environment, of modulation by a channel encoder consisting of two elements: a convolutional code and an interleaver; for this reason, the modulation is called coded OFDM or C-OFDM.

The introduction of the convolutional code (which may be the Reduced Reed Solomon code) adds a certain amount of redundancy to the data which it is desired to transmit, redundancy which, on reception, will be employed in error correction. This error correction has certain limitations, since, if a long sequence of errors appeared at the entry to the decoder, this element would not be capable of decoding correctly. In order to cut down the length of these error bursts so that they can be tackled by the convolutional code, the interleaver is added.

The interleaver introduces a certain amount of disorder in such a way that the adjacent carriers (i.e., carriers that are close to each other in frequency and which may suffer fading simultaneously) are not modulated by consecutive data. If a loss of information transported by adjacent carriers occurs, when the disorder due to the interleaver is undone, the error due to each carrier will be isolated, shortening the length of the burst and facilitating the correction of the errors.

In summary, it can be said that the combined effect of the convolutional code and of the interleaver can be seen as an averaging-out of the local fading effects, above all the spectrum of the signal.

Another type of fading is that caused by the space-time diversity, that is to say delays in the reception of the signal. In order to solve this problem, the invention envisages the use of two antennae, which can be fitted at both ends of a carriage of the train, for example. By means of the use of said two antennae, advantage is taken of the different levels of horizontal and vertical polarization which are caused by the transmission of the signal as a consequence of the reflections on the walls of the tunnels.

The two antennae should preferably be separated by a distance of, at least, λ/3, where λ is the wavelength corresponding to the basic carrier frequency. The antennae should preferably be omnidirectional antennae. Further, the antennae should preferably be positioned in an adequate manner so as to pick up the horizontal and vertical polarization components of the transmitted signal. Further, the antennae should preferably be positioned for optimal reception of the signal, and not hidden by any mechanical elements that could impede an adequate reception of said signal.

### BRIEF DESCRIPTION OF THE DRAWINGS

A FIGURE which helps toward a better understanding of the invention and which is related expressly to an embodiment of said invention which is presented as a non-limiting example thereof will now be described very briefly below.

FIG. 1 is a diagrammatic view of a preferred embodiment of the invention.

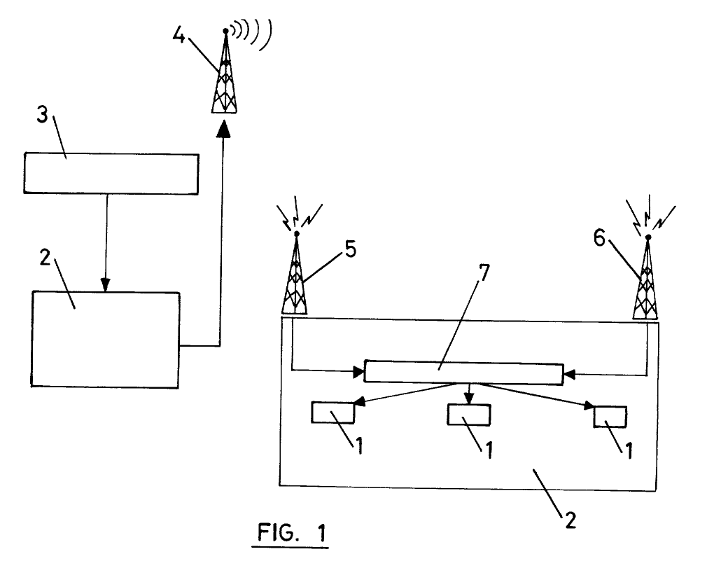

### DESCRIPTION OF A PREFERRED EMBODIMENT OF THE INVENTION

According to a preferred embodiment of the invention, the system includes a plurality of screens (1) distributed throughout one or more carriages (2) of a suburban train.

The system moreover includes, at each end of a tunnel between two stations of the suburban-train network, a DBV-T transmitter (2) which receives video signals from a signal distributor (3) equipped with means for transmitting a signal with C-OFDM modulation (the coded video signal is first interleaved and error coded using a convolutional code, and then transmitted using OFDM modulation; the convolutional code may be a Reduced Reed Solomon code). Said signals are transmitted to the train from the DBV-T transmitter (2), via an antenna (4) located inside the tunnel, close to the platform.

From the antenna (4) the signal, via two antennae (5, 6) situated at each end of a carriage of the train (or at each end of the train, in different carriages), arrives at a DBV-T receiver (7) situated on board the train and equipped with means for receiving the signal with C-OFDM modulation and means for visually displaying images corresponding to the received signal on the screens (1).

The two antennae (5, 6) are separated by a distance of, at least, λ/3, where λ is the wavelength corresponding to the basic carrier frequency. The antennae are omnidirectional antennae. Further, the antennae are positioned in an adequate manner so as to pick up the horizontal and vertical polarization components of the transmitted signal.

1. A system for transmitting information including video images to carriages of trains and visually displaying the video images in the carriages, the system-including:
at least one screen (1) situated in at least one carriage (2) of a train;
characterized in that the system further includes:
at least one DBV-T transmitter (2) equipped with means for transmitting a signal with C-OFDM modulation;
at least two antennae (5, 6) situated on the train;
at least one DBV-T receiver (7) situated on board the train and equipped with means for receiving the signal with C-OFDM modulation via said at least two antennae (5, 6);
means for visually displaying images corresponding to the signal received in the DBV-T receiver, on said at least one screen (1):

2. The system as claimed in claim 1, wherein the train is a suburban-railway train.

3. The system as claimed in any of claims 1 and 2, wherein the antennae are separated by a distance of, at least, λ/3, where λ is a wavelength corresponding to a basic carrier frequency.

4. The system as claimed in any of the preceding claims, wherein the antennae are omnidirectional antennae.

5. A method for transmitting information including video images to carriages of trains for visually displaying video images on screens in the carriages:
characterized in that
a video signal is transmitted from at least one DBV-T transmitter (2), said signal being transmitted with C-OFDM modulation;
said signal is picked up with at least two antennae (5, 6) situated on the train; and
said signal is sent from the antennae to a DBV-T receiver (7) situated on board the train; and
the images corresponding to the video signal are visually displayed on at least the one screen (1).

6. The method as claimed in claim 5, wherein the train is a suburban-railway train.

7. The method as claimed in any of claims 5 and 6, wherein the antennae are separated by a distance of, at least, λ/3, where λ is a wavelength corresponding to a basic carrier frequency.

8. The method as claimed in any of claims 5-7, wherein the antennae are omnidirectional antennae.
